(19) United States
(12) Patent Application Publication
(10) Pub. No.: US 2013/0299588 A1
(43) Pub. Date: Nov. 14, 2013

(54) RFID LABEL

(71) Applicant: YUEN FOONG PRECISION ELECTRONICS (YANGZHOU)CO., LTD., (US)

(72) Inventor: Wen-Tsen LIN, Yangzhou (CN)

(73) Assignee: YUEN FOONG PRECISION ELECTRONICS (YANGZHOU)CO., LTD., Yangzhou (CN)

(21) Appl. No.: 13/889,353

(22) Filed: May 8, 2013

(30) Foreign Application Priority Data
May 8, 2012 (CN) 201220202693.9

(51) Int. Cl. G06K 19/077

(52) U.S. Cl. CPC G06K 19/07798
USPC 235/488

(57) ABSTRACT

Disclosed is a RFID label, comprising a plane material, a separation layer, an antenna, a chip, adhesive and a cover paper. The separation layer is formed on a first surface of the plane material. The antenna is printed with conductive ink on the separation layer, which is formed on the first surface. The chip is connected to the antenna. The adhesive and the cover paper cover the antenna and the chip. With the adhesive, the RFID label can be sticked to an object. The separation layer can be fully or partially formed on the first surface of the plane material. The separation layer can be formed in reticulate patterns, regular intermittent patterns or patterns of overlapping and crossing over the antenna. When the RFID label is separated from the object, the antenna will be separated from the first surface of the plane material where the separation layer is formed.

### BACKGROUND OF THE INVENTION

1. Field of the Invention

The present invention generally relates to a technical field of a RFID label, and more particularly to a RFID label.

2. Description of Prior Art

A RFID label, so called an electronic label using technology of data exchange without contact has been widely utilized in various applications, such as passport, charge card, public transit charge system, high way charge system, any systems for the control management of manufacturing and assembling products, for the deliver management of the luggage, the mails, and the packages, for the files tracing and for the control management of the supply logistics. In the foregoing applications, the RFID labels require to be manufactured with great amount, high speed and low cost for providing necessary amount of the labels. Specifically, as mentioning about the control management of manufacturing and assembling products or the supply logistics, the RFID label seems to be highly potential to replace the present barcode and becomes the main stream of the control management technology. The main reason is that the barcodes still require manual scan one by one. On the contrary, the detector merely needs a short time to complete the confirmations for all the product information once the RFID labels are introduced.

Moreover, the skill of utilizing the nano-metal ink, such as silver conductive ink, has been employed for printing the antenna of the RFID labels. Therefore, the RFID labels as being part of package can be realized. The RFID label can be even directly printed on the same base material of the package for the products. Comparing with the RFID label manufactured by the traditional semiconductor technology (deposition, etching and etc. are essential for building the antenna), which requires high manufacture cost and also attaching operations to the packages for the products cannot be disappeared. Such RFID labels introduce the printing skill. Not only the labels can be manufactured with great amount, high speed and low cost but also the attaching operations can be eliminated. With companion of the aforesaid extremely convenient application, afterwards, the technical issues of security and reliability have to take considerations. When one RFID label represents the most significant uniqueness of one manufacture object or one product, the disposable property, i.e. the tamper resistant function, which the RFID label cannot be recovered after being removed becomes fundamental. For instance, a disposable wristlet is disclosed in Taiwan Patent Publication No. 200836708. However, only the tear line 42 on the base material in FIG. 7 is utilized for leading the damage to the antenna after riving off the wristlet. Only a simple and easy recovery skill is needed to restore the fuction of the disposable wristlet and the original data stored therein can be derived. Consequently, there is a need to develop a new RFID label for solving the aforesaid problems.

### SUMMARY OF THE INVENTION

For solving the aforesaid problems, an objective of the present invention is to provide a RFID label, comprising a plane material, a separation layer, an antenna and a chip. The separation layer is formed on a first surface of the plane material. The separation layer can be fully or partially formed on the first surface of the plane material. The separation layer can be formed in reticulate patterns, regular intermittent patterns or patterns of overlapping and crossing over the antenna. The antenna is printed with conductive ink on the separation layer, which is formed on the first surface of the plane material. The chip is connected to the antenna. The RFID label further comprises adhesive and a cover paper sequentially cover the antenna and the chip. With the adhesive, the RFID label can be sticked to an object. The plane material can be a paper. Release agent can be printing coated on the furst surface and to be cured to form the separation layer. When the RFID label is separated from the object, the antenna will be separated from the first surface of the plane material where the separation layer is formed.

The beneficial effect of the present invention is: the RFID labels can be manufactured with great amount, high speed and low cost. Meanwhile, the separation layer can be fully or partially formed on the first surface of the plane material. Accordingly, when the RFID label is separated from the object, the antenna will be separated from the first surface of the plane material where the separation layer is formed and the antenna will be sticked on the plane material where the separation layer is not formed. Cosequently, after the RFID label of the present inveniton is separated from the object, the RFID label cannot be recovered and provided with tamper resistant function to realize the most significant uniqueness of the object or the product by the RFID label.

### BRIEF DESCRIPTION OF THE DRAWINGS

FIG. 1 depicts a diagram of a printing equipment of manufacturing RFID labels according to the present invention;

FIG. 2 depicts a layering diagram of a RFID label according to the present invention;

FIG. 3 depicts a diagram of a RFID label according to the present invention(not showing a separation layer, adhesive and a cover paper thereof);

FIG. 4 depicts a diagram of a RFID label after being separated from the object which is sticked thereto according to the first embodiment of the present invention;

FIG. 5 depicts a diagram of a RFID label after being separated from the object which is sticked thereto according to the second embodiment of the present invention;

FIG. 6 shows a flowchart of a manufacture method of a RFID label according to the present invention; and

FIG. 7 shows a tear line on the base material according to prior art.

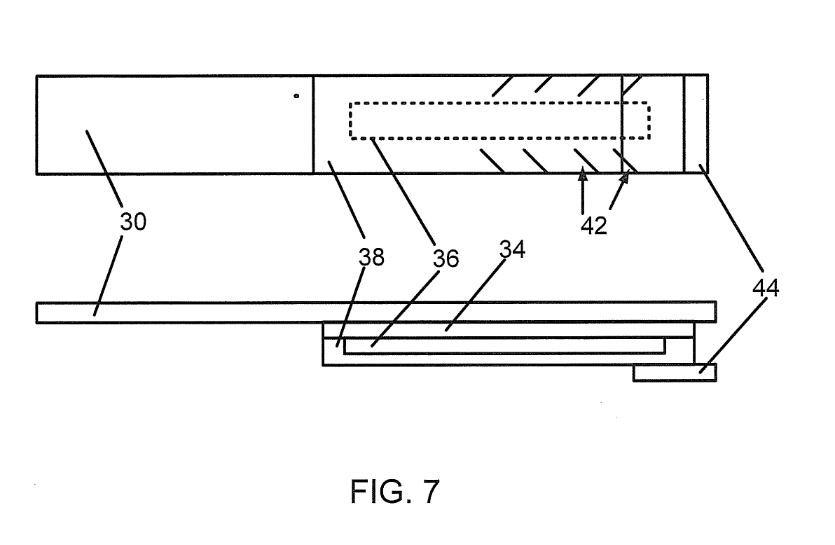

### DETAILED DESCRIPTION OF THE INVENTION

The following descriptions for the respective embodiments are specific embodiments capable of being implemented for illustrations of the present invention with referring to appended figures.

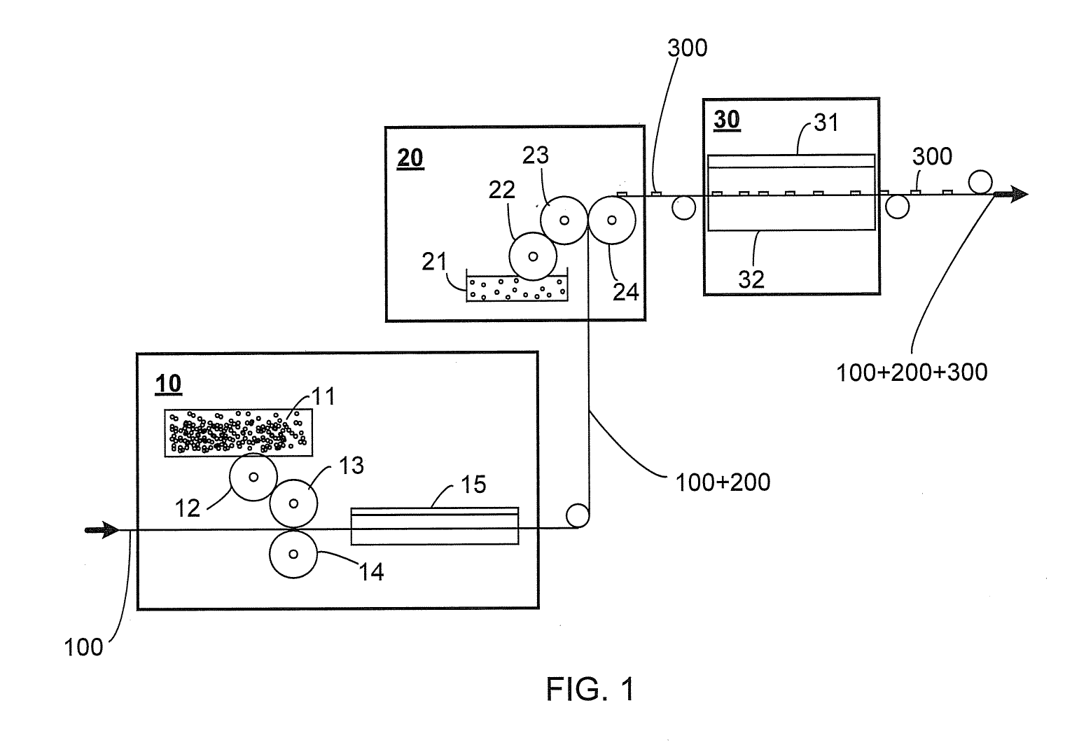

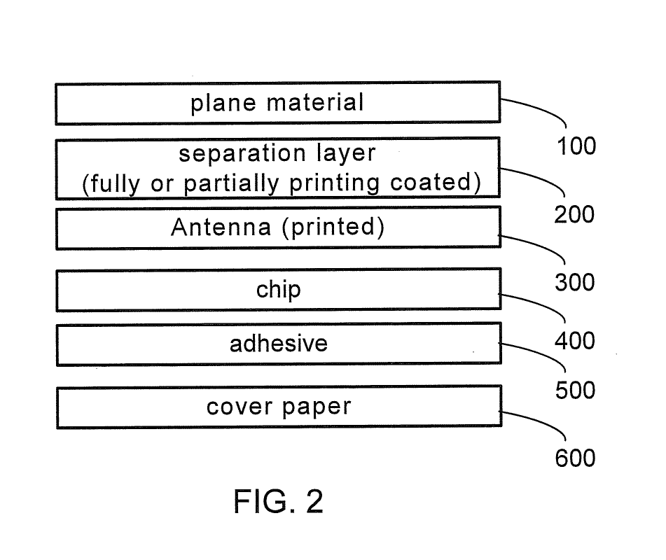

Please refer to FIGS. 1 and 2. FIG. 1 depicts a diagram of a printing equipment of manufacturing RFID labels according to the present invention. FIG. 2 depicts a layering diagram of a RFID label according to the present invention. The printing equipment of manufacturing RFID labels comprises a separation layer printing unit 10, a conductive ink printing unit 20 and a conductive ink heating unit 30. The separation layer printing unit 10 further comprises a supplying unit of release agent 11, a feeding roller 12, a plate roller 13, a stamping roller 14 and a release agent curing unit 15. The conductive ink printing unit 20 further comprises an inking roller 22, a plate roller 23 and a stamping roller 24. The conductive ink heating unit 30 further comprises a heating element 31 and a heating element holding member 32.

The printing equipment shown in FIG. 1 further comprises an unreeling machine and a reeling machine which are not shown. As the arrow indicated in the figure, the unreeling machine unreels the coil stock of the plane material and forwards the plane material 100, such as a paper, to the separation layer printing unit 10. The reeling machine reels the plane material 100 which the antenna has been printed from the conductive ink heating unit 30. As shown in FIGS. 1 and 2, the printing equipment provides the release agent 11 to the feeding roller 12 when the plane material 100 is delivered to the separation layer printing unit 10. The plate roller 13 and the stamping roller 14 are employed for printing coating the release agent 11 on the upper surface (the first surface) of the plane material 100. (The printing equipment is merely a simple diagram rather than a complete and detail diagram of all mechanisms). Then, the release agent curing unit 15 is utilized for curing the release agent 11 printing coated on the plane material 100 to form a separation layer 200. UV curing release agent, heat curing release agent or infrared curing release agent can be illustrated for the release agent 11. Correspondingly, the release agent curing unit 15 can be a UV curing unit, a heat curing unit or a infrared curing unit employing the UV light, the heat source or the infrared light for curing the release agent 11. The separation layer 200 can be fully or partially formed on the first surface of the plane material 100. For instance, the separation layer can be formed on the first surface of the plane material 100 in reticulate patterns, regular intermittent patterns or patterns of overlapping and crossing over the antenna (Detail description is introduced later).

The printing equipment provides the conductive ink 21 to the inking roller 22 when the plane material 100 is delivered to the conductive ink printing unit 20. Then, the plate roller 23 and the stamping roller 24 are employed for printing coating the conductive ink 21 on the separation layer 200, which is formed on the first surface of the plane material 100. The patterns of printing the conductive ink 21 is the patterns for forming the antenna 300. Then, in the conductive ink heating unit 30, the heating element 31, such as an infrared curing element or a hot blast heating element, is utilized for curing the conductive ink 21 which has printing coated on the separation layer 200. Therefore, the antenna 300 can be formed and manufactured. The conductive ink 21 comprises metal nanoparticles, such as silver nanoparticles (After printing coating, the conductive ink can be formed as conducting wires by high temperature sintering).

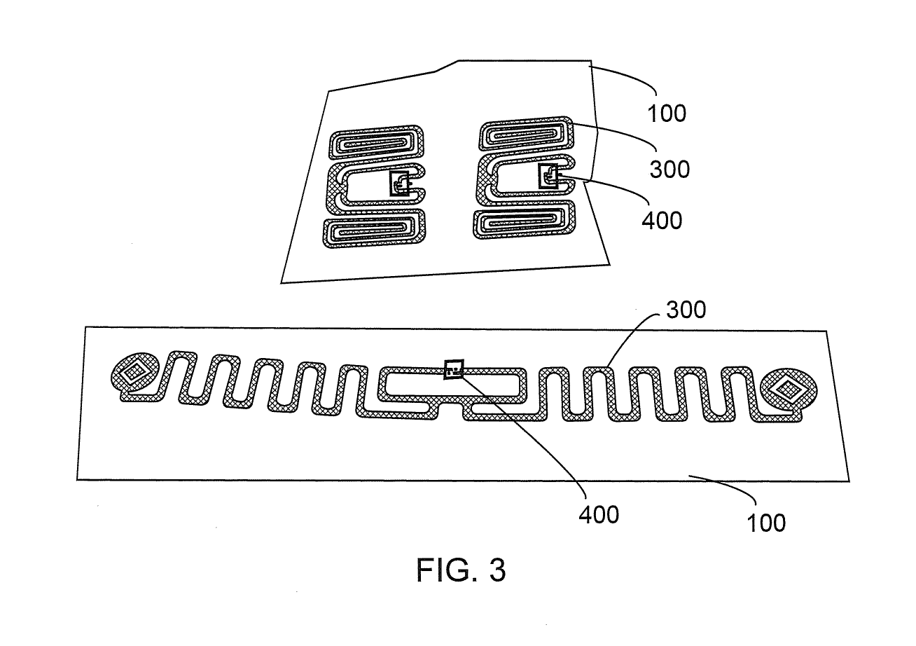

Furthermore, after printing coating the separation layer 200 and the antenna 300 is completed, the coil stock of the plane material 100 can be reversely reeled and various colorful printing can be executed on the second surface of the plane material 100 on the demands of the customization. Alternatively, after printing coating the separation layer 200 and the antenna 300, the printing of the insulation ink and the bridge of the antenna are completed before the various colorful printing on the second surface on the demands of the customization can be executed. After that, a die attached process of the chip 400 is proceeded. In the RFID label of the present invention as shown in FIG. 3 (the separation layer, the adhesive and the cover paper are not shown), the chip 400 is electrically connected to the antenna 300 for realizing the function of RFID label. Then, on the first surface of the plane material 100, which the separation layer 200 and the antenna 300 have formed. A glue machine (not shown) is employed for proceeding the coating of the adhesive 500 (or twin adhesive). The cutting machine is utilized for cutting the plane material 100 for producing the end product (such as self-stick labels or tags). Otherwise, a cover paper 600 is attached onto the first surface of the plane material 100 with the adhesive 500, and then the cutting machine is utilized for cutting the plane material 100 for producing the end product (such as self-stick labels or tags).

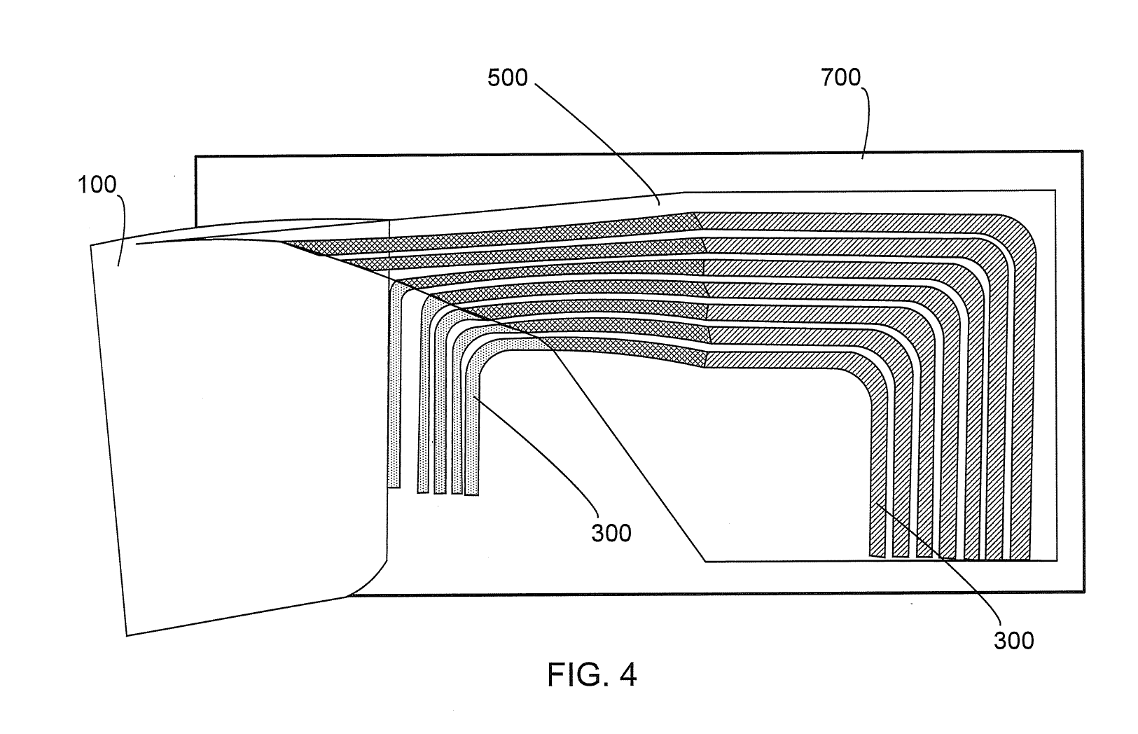

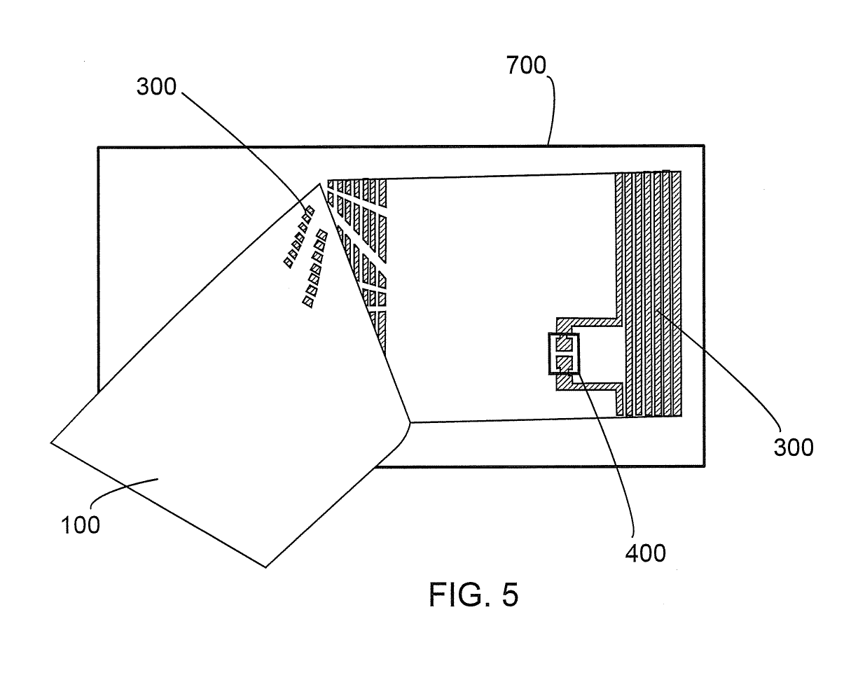

Please refer to FIG. 4 and FIG. 5. FIG. 4 depicts a diagram of a RFID label after being separated from the object 700 which is sticked thereto according to the first embodiment of the present invention. FIG. 5 depicts a diagram of a RFID label after being separated from the object 700 which is sticked thereto according to the second embodiment of the present invention. The RFID label of the present invention can be sticked to an object 700 with the adhesive 500. Moreover, the object 700 is not restricted to a flat object, but a non flat object also can be sticked the RFID label thereto without effecting the function fo the RFID label. When the RFID label is separated from the object, the antenna 300 will be separated from the first surface of the plane material 100 where the separation layer 200 is formed. That is, the antenna will be separated from the first surface of the plane material where the separation layer is formed and will be sticked on the plane material where the separation layer is not formed when the RFID label is separated from the object.

As shown in FIG. 4, in the first embodiment of the present invention, the separation layer 200 is fully formed on the first surface of the plane material 100. When the RFID label is separated from the object 700, the entire antenna 300 will be separated from the first surface of the plane material 100. Accordingly, the RFID cannot be recovered and therefore is provided with tamper resistant function. As shown in FIG. 5, in the second embodiment of the present invention, the separation layer 200 is partially formed on the first surface of the plane material 100. As aforementioned, the separation layer 200 can be formed in reticulate patterns, regular intermittent patterns or any other variant patterns, as long as overlapping and crossing over the antenna 300. As shown in FIG. 5, Partially formed separation layer 200 can make the antenna 300 not only separated but also broken, and even irregularly broken when the RFID is separated from the object 700. That makes the recovery of the RFID label becomes more unlikely possible and therefore the tamper resistant function of the RFID label is promoted in advance. The most significant uniqueness of the object or the product by utilizing the RFID label is further promoted.

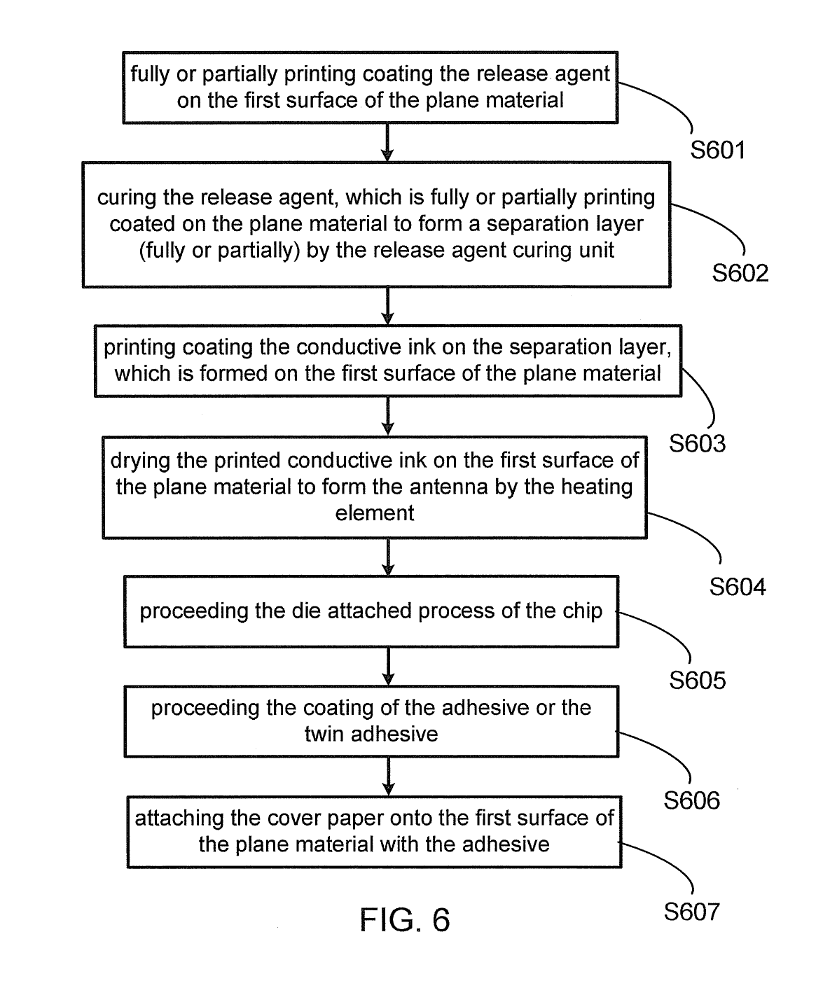

Please refer to FIG. 1, FIG. 2 and FIG. 6. FIG. 6 shows a flowchart of a manufacture method of a RFID label according to the present invention.
Step S601, fully or partially printing coating the release agent 11 on the first surface of the plane material 100;
Step S602, curing the release agent 11, which is fully or partially printing coated on the plane material 100 to form a separation layer 200 by the release agent curing unit 15;
Step S603, printing coating the conductive ink 21 on the separation layer 200, which is formed on the first surface of the plane material 100;
Step S604, drying the printed conductive ink 21 on the first surface of the plane material 100 to form the antenna 300 by the heating element 31.
Step S605, proceeding the die attached process of the chip 400;
Step S606, proceeding the coating of the adhesive 500 (or the twin adhesive);
Step S607, attaching the cover paper 600 onto the first surface of the plane material 100 with the adhesive 500.

Furthermore, between the Step S604 and Step S605, a step of executing various colorful printing on the second surface of the plane material 100 on the demands of the customization can be optional. Alternatively, between the Step S604 and Step S605, after printing coating the separation layer 200 and the antenna 300, the step of printing of the insulation ink and the bridge of the antenna can be proceeded first. Then, the various colorful printing on the second surface on the demands of the customization can be executed. Moreover, after Step S606 or Step S607, a step of cutting the plane material for producing the end product (such as self-stick labels or tags) can be further provided therewith.

In conclusion, the significant feature of the present invention is that the RFID label of the present invention cannot be recovered and therefore is provided with the tamper resistant function after the RFID label is separated from the sticked object. Accordingly, the most significant uniqueness of the object or the product marked by the RFID label can be realized.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A RFID label, comprising:
a plane material;
a separation layer, formed on a first surface of the plane material;
an antenna, printed with conductive ink on the separation layer, which is formed on the first surface of the plane material; and
a chip, connected to the antenna.

2. The RFID label according to claim 1, wherein the plane material is a paper.

3. The RFID label according to claim 1, wherein the separation layer is formed by printing coating UV curing release agent on the furst surface to be cured by UV light.

4. The RFID label according to one of claims 1, wherein the separation layer is formed by printing coating infrared curing release agent on the furst surface to be cured by infrared light.

5. The RFID label according to claim 1, wherein the separation layer is formed by printing coating heat curing release agent on the furst surface to be cured by a heat source.

6. The RFID label according to claim 1, wherein the separation layer is fully formed on the first surface of the plane material.

7. The RFID label according to claim 1, wherein the separation layer is partially formed on the first surface of the plane material.

8. The RFID label according to claim 7, wherein the separation layer is formed on the first surface of the plane material in reticulate patterns.

9. The RFID label according to claim 7, wherein the separation layer is formed on the first surface of the plane material in regular intermittent patterns.

10. The RFID label according to claim 7, wherein the separation layer is formed on the first surface of the plane material in patterns of overlapping and crossing over the antenna.

11. The RFID label according to claim 1, further comprising adhesive covering the antenna and the chip, and the RFID label is sticked to an object.

12. The RFID label according to claim 11, wherein the RFID label is separated from the object, the antenna is separated from the first surface of the plane material where the separation layer is formed.
